(19) United States
(12) Patent Application Publication
(10) Pub. No.: US 2018/0103653 A1
(43) Pub. Date: Apr. 19, 2018

(54) METHOD OF PRODUCING TUNA FISH PIECES

(71) Applicant: NIENSTEDT GMBH, Haltern am See (DE)

(72) Inventors: Petra Groneberg-Nienstedt, Düsseldorf (DE); Uwe Pinz, Hüllhorst (DE)

(21) Appl. No.: 15/560,688

(22) PCT Filed: Mar. 22, 2016
(86) PCT No.: PCT/EP2016/056253

§ 371 Date: Sep. 22, 2017

(30) Foreign Application Priority Data
Mar. 23, 2015 (DE) 10 2015 104 347.5

(51) Int. Cl. A22C 25/18; A23P 30/10; A23L 17/10; A23L 17/00; A23B 4/06

(52) U.S. Cl. CPC A22C 25/18; A23P 30/10; A23V 2002/00; A23L 17/70; A23B 4/06; A23L 17/10

(57) ABSTRACT

The invention concerns a method of producing output wares of the highest possible quality from input wares, wherein the input wares being processed are optically scanned, brought to a target weight, and then formed into a shape suitable for packaging and/or further processing. The invention comprises using deep-frozen input ware, scanning the position, shape and size of the individual input ware by an optical scanning means with direct or indirect consideration of the fiber position of the tuna fish meat, calculating at least one cutting line through the input ware for the cutting off of a tuna fish cut having a desired target weight and/or a desired shape, wherein the calculation of the cutting line involves an optimization process, and cutting along the calculated cutting line in one cutting step.

### CROSS REFERENCE TO RELATED APPLICATIONS

This application is a national stage application under 35 U.S.C. 371 of PCT Application No. PCT/EP 2016/056253 having an international filing date 22 Mar. 2016, which PCT application claimed the benefit of German Patent Application No. 10 2015 104 347.5 filed 23 Mar. 2015, the entire disclosure of each of which are hereby incorporated herein by reference.

### FIELD OF THE INVENTION

The invention concerns a method of producing pieces of tuna fish of the highest possible quality, wherein pieces of tuna fish are brought into the process as input ware and the input ware being processed is optically scanned, brought to a target weight, and then formed into a shape suitable for packaging and/or further processing.

A method for the shaping of deep-frozen fish is known from EP 2 211 635 A1. In this method, pieces of meat or fish are placed deep-frozen in a molding trough and then pressed into a desired shape by two partial pressing steps, wherein the partial pressing steps are configured such that the fiber structure of the meat is preserved as much as possible.

EP 1 811 850 A1 describes a method in which pieces of meat, also in the form of meat or fish, are placed at a desired weight prior to molding in the press. In both methods, the meat or fish is placed deep-cooled into the press and pressed by a pressing ram into a molding trough or pressed by a contoured pressing ram against a flat or contoured abutment surface.

With the known method, it is possible on the one hand to reshape pieces of meat or pieces of fish and on the other hand to compress them in a way such that they stick together in particular due to emerging protein, so that a combined piece can be created from individual pieces of meat which corresponds in appearance to a piece of meat or fish cut out from muscle flesh.

Another method is known from EP 1 988 781 A1 in which pieces of meat or pieces of fish are subjected to a forming step also known as “shaping” in the technical jargon. For this, the meat is at first sorted and prepared in a first sorting step. Fresh or frozen pieces of meat which are below a nominal weight are collected and assembled into clusters, which then correspond to the nominal weight. Pieces of meat which correspond to the nominal weight go into the process straightforward. Pieces of meat which are over the nominal weight are sliced, and the trimmings are once again taken to the first group, while the piece of meat now brought to the nominal weight goes on to the shaping step. Pieces of meat which are not deep-frozen during the sorting are deep-frozen at the end of the sorting. The pieces of meat are then pressed in a molding press to the desired contour as already described above.

After the forming of the piece of meat or the cluster of pieces of meat, either the product is canned or it is further processed as a convenience product. In the course of the packing into cans, fish and especially tuna fish is usually at first cooked and then canned in refrigerated or deep-frozen form. A marinade may then be added, and then the can is sealed and sterilized. A convenience product, in turn, may be breaded after the shaping, for example, and then packed in refrigerated or deep-frozen form. Ultimately, this will depend on the desired shelf life and other requirements of the consumer.

The drawback of the known method is that, while it is basically suitable for the processing of pieces of tuna fish, due to the special nature of the tuna fish the weight-optimized portioning is difficult. This is because tuna fish, unlike many other kinds of fish and meat, cannot be so easily cut and processed. Namely, the comparatively expensive tuna fish is not easy to reshape and compress, like other kinds of fish or animal flesh, for example. There is a risk here of the sensitive fibers of the tuna fish becoming destroyed, so that the impression of a piece of filet is lost and the piece falls apart during subsequent cooking.

### BRIEF SUMMARY OF THE INVENTION

The problem which the invention proposes to solve is therefore to create a method for the shaping of deep-frozen pieces of tuna fish wherein output ware of the highest possible quality is produced.

This problem is solved according to the invention by a method comprising the method steps:
using deep-frozen input wares to carry out the method,
scanning the position, shape and size of the individual input ware by an optical scanning means with direct or indirect consideration of the fiber position of the tuna fish meat,
calculating at least one cutting line through the input ware for the cutting off of a tuna fish cut having a desired target weight and/or a desired shape, wherein the calculation of the cutting line involves an optimization process, through which, besides determining the necessary volume to achieve the target weight after the cutting, the cutting line is established as perpendicular as possible to the fibers of the tuna fish, and
cutting along the calculated cutting line in a cutting step.

The input ware will generally not be symmetrical and must therefore be scanned in shape, position and/or size prior to establishing the cutting pattern. Moreover, it is of course important for this that these quantities are no longer changed afterwards until the cuts are made, or that they can be reproduced once more. Therefore, when scanning the shape, position, and/or size, the input ware is then preferably fixed at least on a tray or already on a cutting device, so that the relation between the scanned shape, position and/or size and the cutting pattern is no longer changed. In the case of regularly shaped input ware or ware with a defined placement and shape, on the other hand, the determination of shape, position and/or size may be dispensed with.

In the context of the description of the method according to the invention, the piece of tuna fish used as the input product shall be called the input ware. These are pieces which are cut out from the whole fish, generally back filets of the fish (so-called “loins”). However, the application of the invention should not be confined to back filets, although these will be the preferred input products. The input ware can also consist of several pieces, e.g., also several back filets, which have been combined by freezing into a cluster or block. Therefore, in the present case we shall generally speak of “tuna fish cuts”. The end product of the method is the output ware.

The purpose of the method is to produce from the input ware or from several input wares an output ware with the highest possible quality appeal while at the same time optimizing the yield. Tuna fish is often offered to the consumer today as cooked preserves, an uncooked steak cut from a piece, or a piece of sashimi or sushi. The meat has a distinctive fiber structure, which is often lost during the processing, especially during the canning.

The filet portions of the tuna fish are sold as back filets in various quality levels. The goal of the present method is to produce pieces of tuna fish of the most uniform possible weight and shape, having the optical appearance of a tuna fish steak cut from a premium grade. Moreover, the valuable and also rare meat in the case of many varieties should be processed completely with the highest possible retail quality. For this, the preferred input ware used will be deep-frozen back filets of premium grade. These are produced either by fileting the frozen fish or are deep-frozen after the fileting of the fresh fish. These deep-frozen tuna fish cuts should then be processed into output ware if possible without a thawing, since a thawing and refreezing has a negative impact on the quality of the meat. For example, the quality feature of “meat color” suffers in this case.

Several improvements are achieved thanks to the method of the invention of producing of shaped tuna fish products.

Thus far in the processing of back filets into high-quality steaks, for example, the unfrozen or also the frozen ware has been portioned “by eye”, resulting in an unsatisfactory yield of high-quality output ware. It is now possible to place the ware in the frozen state at the desired weight and especially in a desired shape. This significantly increases the yield in terms of high-quality output ware. In order to be able to produce as many steaks as possible with a uniform size and the same weight from the frozen input ware, according to the invention the frozen back filet undergoes an optical surveying. This is necessary, in contrast to the previous methods, since the frozen input ware has no regular bottom side, but instead must be individually treated. A back filet has the peculiarity that its diameter decreases from front to rear, and so the thickness of the pieces being cut must always increase from front to rear in order to achieve the same weight.

The determination of the individual pieces being cut is done by the calculating and establishing of an optimal cutting line or usually several cutting lines. Of course, the piece being cut out from the back filet should be given the appearance and the structure of a steak. For this, the back filet is cut in the transverse direction, so that the typical slice pattern of the tuna fish remains intact in terms of the fiber boundaries. Thus, a large region of the back filet can remain intact in premium grade as valuable steak meat.

By the optical surveying, it is possible to slice exactly the frozen ware not lying flat on a cutting base. For this, the cutting lines or planes (the cutting pattern) are calculated and superimposed on the secured input ware, so that cutting can be done afterwards along these lines or planes. The outcome is then pieces of meat of different thickness and the best quality.

The optical surveying of the deep-frozen tuna fish ware can be done in a preferred embodiment of the method by optical sensors, especially cameras and/or also laser triangulation in combination with a corresponding scanning and evaluation. In particular, the processing of the back filets cut from the fish loins can make use of a preliminary orientation of the deep-refrigerated pieces, so that they are basically oriented the same and only the individual measurement deviations of the individual piece need to be scanned and computed.

On account of the cross-section surface diminishing from front to rear, the shape deviation occurring for the same weight can now be corrected by a following shaping process. This shaping process is preferably a pressing process in the course of the so-called shaping. Such a shaping method is known for example from EP 2 211 635 A1. As the result of the shaping process, output ware is furthermore obtained with the appearance of a steak cut out from the filet, but now having a uniform size and shape despite the different initial structure. Of course, not only flat steaks can be produced here, but also many other three-dimensionally contoured shapes.

The application of the invention is also not limited to the production of steaks or the processing of the entire pieces of filet. What is new is the adaptation of the cutting process to the end product desired by the user thanks to the choice of the suitable raw material and the optimized cutting process after the optical surveying of the input ware used as the input pieces. This optimization is done oriented to weight so that the most valuable possible pieces can be produced, valuable here meaning that pieces that are as coherent as possible, similar to a natural steak, have the greatest economic value, while small pieces are classified as less economically valuable and when they fall below a certain minimum size they are sent on for other processing.

The input product used for the method of the invention (as already described above) can be deep-frozen back filets (filet pieces) or also deep-frozen blocks of combined pieces. They may be cooked or uncooked wares. Insofar as block ware is being processed, this need not consist of entire pieces of the back filet, but also several cuts of pieces of the filet or other pieces can be processed here.

After making the portion cuts, the input ware not conforming to the target, i.e., underweight or not the right shape, is removed from the process, unless it can or should be processed together with other pieces of tuna fish to form a piece resembling a steak. These removed pieces can then be combined for example to form uncooked blocks and undergo further processing in an application allowing lower demands on the quality, meaning by quality not the freshness, but rather the cohesive fiber structure of the meat.

The making of the portion cuts is automated with the aid of calculated cutting lines or planes of a cutting pattern, taking into account the result of the optical surveying of the individual pieces of meat. Here, besides the basic shape of the pieces of meat, the position of the fiber structures is also scanned and factored into the calculation of the cutting lines, so that the cutting lines are made preferably at right angles or at an angle between 45° and 90° to the run of the fibers. In certain applications, especially in the case of blocks, the cutting can be for the most part parallel to the run of the fibers. A cutting line may be straight or curved.

The removed ware may be packed as simple canned ware, for example, and offered at an attractive price, the individual pieces in this case being rather small and being usable for example as a garnish for a salad or also a tuna fish pizza.

The pieces not removed and having the desired target weight may already have the desired shape due to the portion cutting. But this will be the case only with the fewest of products. The majority of the pieces will then be brought to an identical shape by the shaping process. Moreover, it may be possible of course that a uniform shape is not even desired, so that in these instances the shaping press step can even be omitted, or different shapes are produced.

The ware so produced may then be marinated in all instances, or packed and stored or delivered without the addition of marinade.

If, instead of the individual filet pieces, blocks of deep-refrigerated ware which is cooked prior to deep freezing are being processed, these may at first be produced by suitable combining of the individual pieces of meat before or after the cooking process to form the blocks and then deep freezing. A preshaping may occur here already during the deep freezing, for example by placing the filet pieces one alongside another in a freezing mold, so that blocks of different dimension and shape can be produced. These blocks need not have any regular or symmetrical shape, and for example even smaller filet pieces can be assembled into the shape of a single larger filet.

Preferably the fiber orientation of the meat is considered in the placement, so that the individual pieces are arranged with fiber orientation parallel to each other. In order to allow for the cross section diminishing from front to rear, fish pieces may be arranged alongside each other with alternating 180° rotation relative to each other.

If the block as described above has been produced homogeneously, with fiber orientations parallel to each other, and has well-defined outer contours, an optical surveying of the individual blocks may be omitted. Otherwise, a surveying is also done here in order to optimize the yield of high-quality output ware. For example, the appearance of the lateral surfaces can be used here to determine the run of the fibers. The dimensions of the blocks with defined outer contour are not standardized, as in the white fish industry, but instead may be oriented to the end product and the associated optimal cutting pattern.

After the cutting of these cooked, deep-frozen blocks into the individual portions, the weight may be checked once more, after which the then produced pieces of meat, usually disk-shaped with round or rectangular cross section, for example, are subjected to the shaping process in the pressing device. By this shaping, the product then takes on an appearance which is oriented to the fibers of natural pieces of filet. The degrees of reshaping may often be modest, since in many instances it is only necessary to create a contour which corresponds at its peripheral surfaces to the peripheral surface of a natural piece of filet. At the same time, the top and bottom of the piece may still preserve the contour of a hand-carved piece with rather uneven surface.

The pieces so produced are then further processed, for example packaged or canned, and here as well a marinade may be added after the packing, and then the can may be sealed and sterilized in the sealed state.

Alternatively to the production of pieces resembling steaks, which are at first cut from the filet pieces (back filets) and pressed into shape, the deep-frozen filet piece at least from the front region of the filet piece may also be reshaped via the pressing die so that pieces resembling steaks can then be cut from the shaped body so produced. Here as well an optical scanning is done in order to determine the fiber position or the run of the fibers and the optimal length of the piece of filet being subjected to the shaping, in order to determine the respective necessary cutting process to produce a piece of optimized weight and quality.

Similar to the method described above, one may also work with uncooked ware. In this case, the blocks are assembled from uncooked, i.e. raw tuna fish by combining the individual pieces, likewise preferably with parallel fiber orientation, and deep frozen. As already mentioned, here as well the blocks may have different outer contours, with the resulting requirements for the optical surveying. Here as well, portion cuts are made in order to trim the product to the desired weight. This slice of raw tuna fish will then be reshaped in the pressing device and further processed in the already described manner by canning or convenience food processing.

Especially when the raw ware used in the method is supposed to be cooked after the pressing process, it is especially advantageous for the pieces to have a uniform shape. The uniform shape and thickness makes it possible to cook the piece homogeneously, whereas previously there have been difficulties during the cooking of whole pieces of filet on account of the different thicknesses. The cooking is usually done on belts which run through a combination oven, combining hot air with steam.

If now, as in the traditional method, whole pieces of filet are cooked in a cooking process, for a corresponding setting of the cooking time and heat the front, thicker region of the piece of filet will be cooked through. But this necessarily means that the rear, thinner region will be overcooked. On the other hand, if the cooking process is shortened or the heat is reduced, the product in the front region in turn will not be cooked through. By the creating of homogeneous pieces, regardless of whether the ware is pressed to shape before or after the cutting, a substantially more harmonious cooking can now be accomplished, which greatly facilitates the manufacture of quality-optimized cooked pieces.

One advantageous variation of the method—which has already been presented and shall be again summarized in this place—is the combining of unfrozen cooked or raw pieces of tuna fish to form a block. This is characterized by the method steps:
producing the block by combining unfrozen tuna fish parts into at least one cluster of tuna fish parts,
forming of the unfrozen block into an application-oriented final shape from the cluster of tuna fish parts in the unfrozen state and deep-freezing of the block so shaped, or
deep-freezing of the block and subsequent forming of the block to the desired, application-oriented final shape by slicing and/or reshaping in a pressing device, in which the block is brought into an application-oriented shape under pressure by a pressing ram, or
shaping the block and deep-freezing regardless of the further use, performing the optical surveying once the ultimately desired piece of tuna fish is obtained, and
creating the pieces of tuna fish by slicing the block into pieces.

This method is substantially characterized in that unfrozen tuna fish parts, which cannot be used as a single piece for example on account of their size, are processed while preserving their quality as much as possible. For this, at first those tuna fish parts are preferably collected which are suitable for the processing according to the invention. Preferably already during the combining of the tuna fish parts one will make sure that the application-oriented end product can be produced from them with the highest possible quality.

By the application-oriented end product is meant here that the meat structure, especially the run of the fibers, of the tuna fish is already considered during the assemblage of the individual blocks and also during the processing of this block. As a result, despite the fact that the piece of tuna fish produced via the method generally consists of several individual parts, the optical impression of a tuna fish product presumably cut from one piece can remain largely intact.

Furthermore, it can be the goal of the method that even though it is recognizable that the piece of tuna fish consists of several individual parts, nevertheless it remains recognizable that these individual parts are parts of high quality. For this reason, the term piece of tuna fish should also be considered to mean a combination of individual pieces which are offered in cohesion, for example, sold in a can.

Now, by the method the unfrozen tuna fish parts are at first assembled into blocks, i.e., combinations of individual parts or filets. One will make sure here that the tuna fish parts of course on the one hand have a sufficient quality, but on the other hand they are oriented during the assemblage of the blocks as much as possible so that, despite the further processing, the piece of tuna fish produced afterwards has a cross-section surface visible to the end consumer over the largest possible area with the typical appearance of a piece of filet carved transversely to the direction of the fibers.

Now, at first a cluster is assembled from the unfrozen tuna fish parts, which can then already be the finished block for further processing in the most simple instance. In this condition, the tuna fish meat is not frozen.

It is possible on the one hand to place the tuna fish parts together and to freeze them lying against one another. One can then cut out for example a cubic block from this cluster, or in the case of an endless cluster production one can make cuts from the latter. Thus, in one embodiment of this method, tuna fish parts can be placed at a predetermined fill height on a conveyor belt or placed in molds, and then the deep freezing is done. In the case of the conveyor belt, an endless band of frozen tuna fish can be produced in this way, which after moving through the freezing station is broken down into the blocks by making a cut arranged for example at right angles to the direction of advancement. The cuboidal blocks so produced can either be used further directly or be brought into the desired end shape of the block by a later pressing station, yet to be described.

In the event that individual molds are used for the block, this mold may of course already have the final shape of the block, at least in terms of the side walls and the bottom. Furthermore, it is possible to place the tuna fish parts already in suitable orientation in an elastic shell, in which they can then be deep-frozen for example into a cylindrical shape. Such a shell may be for example the skin in the form of a natural or synthetic intestine as is known in sausage production.

A good quality impression for the later-produced piece of tuna fish is obtained if the pieces of tuna fish within the cluster and thus also within the block later made from it are already oriented so that the later cutting pattern comes as close as possible to the consumer's wishes. For this, the tuna fish pieces are often arranged so as to allow for the later cutting pattern, when the block is subsequently cut into pieces. Thus, in many applications, the consumer will prefer a view of the sliced fibers of tuna fish meat, since this also gives the visual impression of being filet meat. Thus far, it has been a problem that even when filet meat was processed, the visual impression was lost due to the processing.

The fact that the cutting pattern is adapted to the consumer's wishes is described by the term “application-oriented” in the present context. Thus, for example, when producing canned ware the tuna fish can be assembled into blocks, the blocks having a cross-sectional shape corresponding to the cross-sectional shape of the can. If the fiber of the individual tuna fish parts of these products is oriented so as to be arranged along the longitudinal direction of the block and transversely to the later slicing direction when cutting off the pieces from the block for canning, the consumer can afterwards see the right-angled sliced fibers of the meat in the can. The result is a significantly higher quality impression as compared to a canning with no controlled orientation.

The cluster made from the individual tuna fish parts can already have the shape of the block, so that an explicit shaping of the block is then only necessary when this is not the case. Moreover, the clusters could of course also be formed so that they already have the final shape of the piece of tuna fish, but this will rather be the exception. Instead, in most applications, the block will possess in particular an integer multiple of the weight of the tuna fish pieces being produced, so that the desired tuna fish pieces can be produced from the block.

For example, the block can be cylindrical or cuboidal, or have a different surface, and the tuna fish pieces can be a disk from the block or also a portion of a disk; in the latter case the disk from the block would usually be further broken up into individual pieces. It is important that, depending on the desired end product, the cutting lines are oriented to the fiber direction of the tuna fish meat or adapted to that direction. Thus, usually an orientation at right angles to the fiber will be preferred. However, it may be otherwise in an individual instance, and for example a longitudinal cut may be made, running parallel to the fibers.

In the case of an irregular surface of the block, it will undergo an optical surveying to optimize the cutting lines.

The intermediate products made from the block may be packaged directly, as already described above, for example they may be canned. Of course, steak-like products can also be produced in this way from individual tuna fish parts, which are heat-sealed in film for example and can be marketed in this way.

Preferably, especially in the context of the industrial manufacturing, one will ensure already during the assemblage of the cluster of tuna fish parts, or at latest during the production of the block, that the requirements in terms of weight can be achieved as easily as possible. For example, if the block is being produced from the clusters, or if the clusters are already the finished block, they will preferably have an integer multiple of the weight of the desired tuna fish pieces. Of course, this is only necessary when the tuna fish pieces are supposed to have a uniform weight. On the other hand, this can be omitted when no value is placed on it, for example because the commercial laws do not require it or because the pieces can be sorted afterwards to make up an overall weight to be achieved.

The method can be used to produce tuna fish pieces having a high quality impression on account of the suitable arrangement of the fibers of the tuna fish meat within the cluster. Thus, for example, the block may also have the shape of a classical back filet, from which steaks or canned ware can then be cut by making cuts transversely to the longitudinal direction of the presumable back filet. The orientation of the tuna fish parts in the cluster or block and the cutting lines are usually chosen or arranged such that the tuna fish is sliced transversely to its fiber direction. This need not always be an angle of 90° to the fiber direction; smaller angles, such as between 45° and 90°, can also provide a good result. Finally, depending on the application, it may also be feasible to divide the cluster by lengthwise cuts, in order to cut the tuna fish into strips, for example.

If the tuna fish meat is supposed to be delivered deep-frozen, the optimal division of the block into equal-weight portions with defined run of fibers is ascertained with the aid of the optical scanning. A second variant may be to first thaw out the delivered ware and then form it into a block, which is optimized in dimensions to the application-oriented final shape and then deep-frozen. However, the second variant results in a loss of quality—due to the double thawing processes.

Further features and benefits of the method according to the invention will emerge from the following description of a preferred sample embodiment of the invention with the aid of the drawings.

### BRIEF DESCRIPTION OF THE DRAWINGS

The drawings show:

FIG. 1 a sliced back filet of a tuna fish with schematic representation of the cutting lines,

FIG. 2 in schematic view, the process of shaping, and

FIG. 3 the subsequent canning of the shaped piece as a sample application.

### DETAILED DESCRIPTION OF THE INVENTION

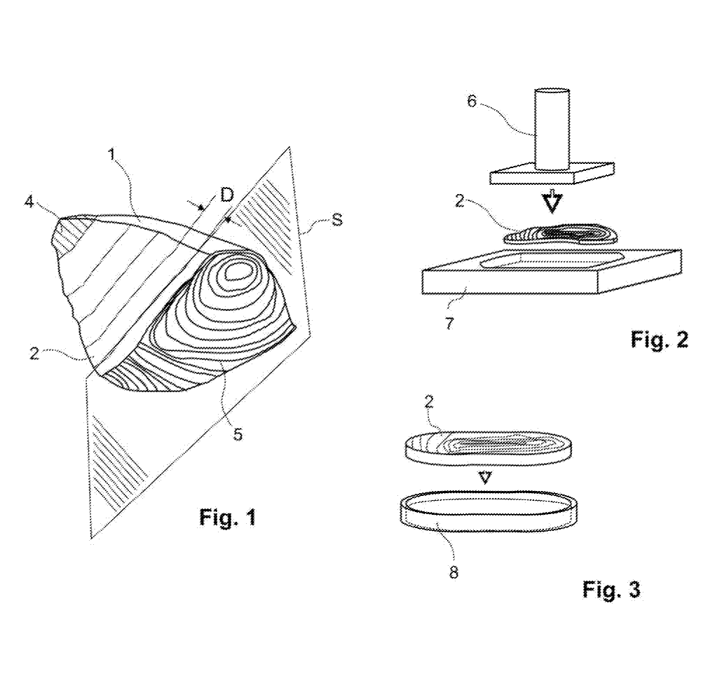

FIG. 1 shows schematically an input ware 1 in the form of a back filet or piece of filet. As can be recognized, the size of this piece of filet diminishes continuously from front to rear. Now, tuna fish steaks are to be made with the method according to the invention as pieces 2 having a uniform size, in addition to an identical weight.

Such a method can be used, for example, to be able to provide identical pieces 2 as output ware for finished food products or also in large kitchens. This has the advantage, on the one hand, that the consumer will find the same shaped piece 2 in each package and thus will assume a uniform quality and size of the tuna fish portion.

Another advantage, which is important in particular during food preparation in large kitchens, such as cruise ship restaurants, is that the same size and shape of pieces 2 can be prepared uniformly. Thus, for example, a lot of pieces 2 placed alongside each other can be prepared in a food steamer or oven with the same cooking time and the same result of being cooked-through, without thinner pieces 2 being overcooked or thicker pieces 2 not yet fully done.

As is shown schematically in FIG. 1, the pieces 2 with the same weight are cut from the input ware 1. Since the tuna fish becomes thinner toward the rear, the thickness D of the disk-shaped pieces 2 increases as the slicing progresses. The thickness D results from determining, by the optical scanning and a subsequent calculation, the cutting plane S needed each time in order to produce pieces 2 of the same weight.

The rear remnant 4 of the input ware 1 is too small or the necessary degrees of transformation would be too great to form another steak-like piece 2 from it. Therefore, this rear remnant 4 is preferably taken to a different processing, such as the processing of the back filets of lower grades, canned along with shredded ware, or offered as a topping for pizzas or also as a smaller piece, yet with cohesive fiber structure.

The pieces 2 in the sample embodiment of the method shown are reshaped in a molding trough 7 into an identical shape. For this, the piece 2 inside the molding trough 7 is “shaped” by a pressing ram 6, i.e., brought to the basic area and marginal contour of the molding trough 7.

FIG. 3 shows an optional extension of the method. Here, the form of the molding trough 7 of FIG. 2 is adapted to the contour of a package, such as a can. In this way, the filet piece so produced fits exactly into the package and can be marketed without breakage or destruction of the fibers.

Alternatively, of course, the deep-frozen pieces 2 after the reshaping can also be sold as steaks in a common repackaging. The preservation of the fiber structure which results in particular from the targeted slicing of the pieces 2 and the subsequent gentle shaping is critical to the producing of the quality impression. Moreover, the degrees of reshaping in the shaping process are preferably kept low.

1. A method of producing pieces of tuna fish of the highest possible quality from input wares, so that an optimal yield of the input wares is achieved, wherein the input wares being processed are optically scanned, brought to a target weight, and then formed into a shape suitable for packaging and/or further processing, wherein the method comprises the steps of:
using an input ware in the form of one or more deep-frozen pieces of tuna fish to carry out the method, wherein in the case of two or more pieces of tuna fish these are combined into a cohesive, contiguous cluster or block,
scanning the position, shape and/or size of the input ware by an optical scanning means with direct or indirect consideration of the fiber position of the tuna fish meat,
calculating at least one cutting pattern for the input ware for the cutting of a tuna fish cut having a desired target weight and/or a desired shape, wherein the calculation of the cutting pattern involves an optimization process, through which, besides determining the necessary volume to achieve the target weight after the cutting, the cutting pattern is defined for the orienting of the fibers of the tuna fish meat and the optimal yield from the input ware is established;
cutting along the calculated cutting pattern in at least one cutting step along at least one cutting line or plane dictated by the cutting pattern.

2. The method of producing pieces of tuna fish as claimed in claim 1, characterized in that the cutting pattern comprises at least one cutting line, running at an angle between 45° and 120°, to the fibers of the tuna fish.

3. The method of producing pieces of tuna fish as claimed in claim 1, characterized in that the tuna fish cuts are sorted after the cutting step, wherein
tuna fish cuts having the target weight and the desired shape are sent on as the product of the method for further processing,
tuna fish cuts having the target weight but not the desired shape are subjected to a shaping process, and
tuna fish cuts which are lighter than the target weight are sorted out for processing in another process or combined into a combination of several tuna fish cuts so that the total of the weights corresponds to the target weight and the combination of deep-frozen filet parts so formed is subjected to the shaping process.

4. The method of producing pieces of tuna fish as claimed in claim 3, characterized in that the shaping process comprises placing the deep-frozen tuna fish cuts or the combinations of deep-frozen tuna fish parts into a press mold, where they are shaped under pressure in a mold and/or by a contoured pressing ram of desired form into an output ware with desired target weight and desired shape.

5. The method of producing pieces of tuna fish as claimed in claim 4, characterized in that the tuna fish cuts or the combination of tuna fish parts are placed in the pressing device such that the pressing force is applied parallel or transversely to the fiber direction of the tuna fish meat.

6. The method of producing pieces of tuna fish as claimed in claim 1, characterized in that the input ware is tuna fish back filets.

7. The method of producing pieces of tuna fish as claimed in claim 6, characterized in that the tuna fish back filets are sliced before or after the freezing and the optical scanning, wherein the volume of the tuna fish back filet is scanned and the size of the piece to be cut off is calculated.

8. The method of producing pieces of tuna fish as claimed in claim 1, characterized in that the input ware is cooked prior to the deep-freezing and the optical scanning.

9. The method of producing pieces of tuna fish as claimed in claim 1, characterized in that in the case of input ware consisting of a combination of several filet pieces, the input wares are assembled such that the fiber structures of the individual pieces are oriented substantially parallel to each other.

10. The method of producing pieces of tuna fish as claimed in claim 1, characterized in that the quantity of filet pieces assembled in the combination of input wares corresponds to the target weight and is adapted to the size of the output ware being formed.

11. The method of producing pieces of tuna fish as claimed in claim 1, characterized in that the input wares are preshaped prior to the optical scanning in frozen or unfrozen state.

12. The method of producing pieces of tuna fish as claimed in claim 1, characterized in that the tuna fish pieces forming the input wares are refrigerated to a temperature below −5° C.

13. The method of producing pieces of tuna fish as claimed in claim 1, characterized in that the output ware is tuna fish pieces with an appearance close to the appearance of a tuna fish steak carved from a filet.

14. The method of producing pieces of tuna fish as claimed in claim 1, characterized in that the input ware or the output ware is marinated before, during or after the steps of the method according to claim 1.

15. The method of producing pieces of tuna fish as claimed in claim 1, characterized in that, when using two or more pieces of tuna fish as a combined block, the block is produced so that the portioning by cutting according to the cutting pattern can be done whilst preserving a high quality and substantially retaining the fibers pattern.

16. A method of producing pieces of tuna fish, characterized by
producing at least one block from raw or cooked tuna fish parts, by combining the tuna fish parts from a combination of tuna fish parts lying alongside and/or clinging to each other into a block,
then forming the so-produced block, frozen or unfrozen, to a desired shape, wherein
the block is formed into an application-oriented final shape and, unless already frozen prior to the forming, frozen after the forming, wherein
the block is formed into the desired, application-oriented final shape by a shaping deep-freezing in a mold, slicing and/or reshaping in a pressing device, in which the block is brought into the application-oriented shape under pressure by a pressing ram, and
creating formed pieces of tuna fish as output ware by slicing the block into pieces.

17. The method as claimed in claim 16, characterized in that the tuna fish parts are trimmed before or after being assembled into the combination of tuna fish parts forming the block, so that the block has a predetermined target weight.

18. The method as claimed in claim 16, that an optimization of the cutting lines is done by optical surveying of the block, making possible an optimal yield of target-weight end products with high quality.

19. The method as claimed in claim 17, characterized in that the block is produced and/or shaped by filling the unfrozen combination of tuna fish parts into an elastic shell.

20. The method as claimed in claim 19, characterized in that the shell with the as yet unfrozen combination of tuna fish parts is placed in a mold whose inner contour corresponds to the desired outer contour of the block, whereupon the shell with the as yet unfrozen clusters of tuna fish parts is deep-frozen in the mold to produce the shaped block.

21. The method of producing pieces of tuna fish as claimed in claim 1, characterized in that the tuna fish pieces produced as output ware according to claim 1, are placed in the frozen state by a suitable process in automated manner into a package.

22. The method as claimed in claim 20, characterized in that the block is formed and has a diameter such that the block corresponds to the diameter of an average head region of a tuna fish back filet of premium grade or corresponds to the size of a tuna fish steak or a customary canned package between 50 mm and 250 mm.

23. The method as claimed in claim 21, characterized in that the slices cut from the block are further divided.

24. The method of producing output wares as claimed in claim 1, characterized in that the resulting shaped output wares and the tuna fish steaks in the frozen state are placed by a suitable method in automated manner into the final package.
